(19) United States
(12) Patent Application Publication
(10) Pub. No.: US 2013/0055639 A1
(43) Pub. Date: Mar. 7, 2013

(54) MOTOR VEHICLE WITH A REAR FLAP

(71) Applicant: Karsten BROSSEIT, Riedstadt (DE)

(72) Inventor: Karsten BROSSEIT, Riedstadt (DE)

(73) Assignee: GM GLOBAL TECHNOLOGY OPERATIONS LLC, Detroit, MI (US)

(21) Appl. No.: 13/606,101

(22) Filed: Sep. 7, 2012

(30) Foreign Application Priority Data
Sep. 7, 2011 (DE) 10 2011 112 684.1

(51) Int. Cl. E05F 15/20

(52) U.S. Cl. 49/31

(57) ABSTRACT

A motor vehicle includes, but is not limited to a rear flap, pivotable about a horizontal axis, to which a sensor, operating in a contactless manner, is associated, which on an approach to an obstacle present in the pivoting range of the rear flap actuates a device that prevents or interrupts the pivoting of the rear flap.

### CROSS-REFERENCE TO RELATED APPLICATION

This application claims priority to German Patent Application No. 10 2011 112 684.1, filed Sep. 7, 2011, which is incorporated herein by reference in its entirety.

### TECHNICAL FIELD

The technical filed relates to a motor vehicle with a rear flap which is able to be pivoted automatically about a horizontal axis.

### BACKGROUND

DE 199 33 804 A1 discloses a motor vehicle with at least one door, able to be pivoted about a substantially vertical axis, with a locking device, actuated by auxiliary force, for limiting the door opening angle. A sensor, operating in a contactless manner, situated on the outer door edge facing away from the axis, is associated with the locking device, which sensor, on an approach to an object adjacent to the motor vehicle while the door is being opened at a defined distance from this object actuates the locking device almost without any time lag, in the sense of a locking. In this motor vehicle, a collision owing to a door which is opened too wide is prevented, wherein an opening process which is already in progress is stopped by the additional locking device, and a distance from an object is detected by an additional sensor system.

Modern motor vehicles are increasingly being equipped with an automatically pivotable rear flap. An opening process is initiated, e.g., by a signal of a radio remote control, i.e., the rear flap is unlocked and is pivoted with a motor into a position which is predetermined by the factory. This is a problem when the user is situated in an unfavorable position and cannot correctly estimate the location of obstacles in the rear region of the motor vehicle, because a collision of the rear flap with an obstacle generally leads to damage to the rear flap. Proceeding from this previously described prior art, a motor vehicle is desirable such that its rear flap is to be opened without the risk of damage.

In addition, other problems, desirable features and characteristics will become apparent from the subsequent summary and detailed description, and the appended claims, taken in conjunction with the accompanying drawings and this background.

### SUMMARY

A motor vehicle comprises a rear flap which is automatically pivotable about a horizontal axis, to which a sensor is associated operating in a contactless manner, which on an approach to an obstacle present in the pivoting range of the rear flap actuates a device which prevents or interrupts the pivoting of the rear flap. The arbitrarily configured and arranged sensor detects an obstacle in the pivoting range of the rear flap, i.e., in particular already in the case of a movement from the closed position about an arbitrary pivoting angle, and brings about an actuation of the device, almost without any time lag, in order to stop the pivoting, for example by means of a braking device, where a damage to the rear flap owing to an obstacle in the pivoting range is effectively prevented.

For example, the sensor can detect the entire rear region of the motor vehicle or only a particular section, and can be arranged both so as to be pivotable jointly with the rear flap and also so as to be fixed relative to the rear flap. In particular, it is possible to arrange the sensor at a prominent point of the rear flap, such as for example in the region immediately beneath a rear window in a bent course of the body. The sensor can be embodied as an ultrasonic, radar or camera sensor or suchlike. Of course, a plurality of sensors can be mounted to increase the accuracy of detection and/or to increase the region which is monitored.

Preferably, the sensor is a parking sensor, which is integrated in a rear bumper. Accordingly, with the parking sensors which are usually present in a modern motor vehicle, which serve as a reverse parking aid, an obstacle can be detected behind the motor vehicle. If the rear flap is pivoted for opening, it can generally sweep through a small pivoting angle without arriving with its free flap edge out from the region of the rear bumper. If an obstacle is detected during this slight pivoting, the further pivoting of the rear flap is prevented. Through the parking sensor, several of which can of course be installed in the rear bumper, an obstacle is detected which is present substantially parallel to the rear bumper. The arrangement of the detected obstacle relative to the rear bumper can of course vary depending on the installed parking sensors, in particular on the number and arrangement thereof.

In an embodiment, the sensor is a distance sensor installed in the rear flap, in particular in the region of a rear flap edge lying opposite the axis, or is a camera coupled with an image processing system. The sensor, associated with the rear flap for example centrally on the free rear flap edge, detects an obstacle in the pivoting range of the rear flap, i.e., also above the rear bumper, such as in particular a ceiling panel of a garage or an at least partially opened garage door, which is pivoted under the ceiling panel. Obstacles in the pivoting range of the rear flap can also be detected and evaluated by the camera with associated image processing system, as is used for example in an optical parking assistance system.

In order to warn the user, the sensor, on detecting an obstacle, actuates an optical and/or acoustic signal device to emit a signal which is able to be perceived for the user of the motor vehicle. For example, the user can be informed by a signal tone, able to be perceived in particular also outside the motor vehicle, which is to be heard several times in succession, that the opening process of the rear flap is stopped. It can also illuminate a display in an instrument, for example in the instrument panel, or present a textual display for the information of the user of the motor vehicle, e.g., rear flap stopped.

Preferably, the device comprises a servomotor associated with the rear flap for the pivoting for opening or closing. Through the servomotor, not only can the pivoting movement take place, but also the stoppage of the rear flap can be brought about in an arbitrary position, in particular in front of an obstacle, without providing a further device.

For comfortable actuation, the device is coupled with a push button in the driver's area and/or on an inner side of the rear flap and/or on an outer side of the rear flap and/or a remote control. If the push button is actuated, the device, for example the electric servomotor, receives a signal for pivoting the rear flap into its respective final position or until the sensor detects an obstacle.

According to a further embodiment, an actuation of the push button on the outer side of the rear flap or for the duration of the actuation of one of the push buttons, the device pivots the rear flap also in the case of a detected obstacle in the pivoting range. If the push button is pressed on the outer side of the rear flap, the user is generally situated immediately behind the rear flap and constitutes an obstacle himself As the user can see an obstacle potentially damaging the rear flap when he is situated behind the rear flap and presses the push button which is arranged there in the outer side of the rear flap, an automatic cut-off of the pivoting process is not necessary. In order to also continue the pivoting process of the rear flap in the case of a detected obstacle, the device is alternatively or additionally actuated for the duration of the actuation of one of the push buttons for pivoting the rear flap.

So that the pivoting of the rear flap is now ended or prevented when a detected obstacle is situated at a critical distance from the rear flap, a minimum distance is stored in a control apparatus connected with the device and with the sensor, wherein the device pivots the rear flap as long as the minimum distance between an obstacle and the sensor is maintained. Hereby, the opening height of the free rear flap edge or respectively the opening angle of the rear flap can be adapted to the environmental conditions and maximized.

Preferably, the device cooperates with an electric rear flap lock of a central locking system and on falling below the minimum distance between an obstacle and the sensor, in the closed position of the rear flap an unlocking of the rear flap is prevented. Thereby, the rear flap is held in its closed final position and already the slightest pivoting, for example by the springing open of the rear flap on its unlocking, is avoided.

It shall be understood that the features mentioned above and to be further explained below are able to be used not only in the respectively indicated combination, but also in other combinations.

### BRIEF DESCRIPTION OF THE DRAWINGS

The present invention will hereinafter be described in conjunction with the following drawing figures, wherein like numerals denote like elements, and:

FIG. 1 is a diagrammatic illustration of a motor vehicle with an opened rear flap and with an obstacle at the rear side; and

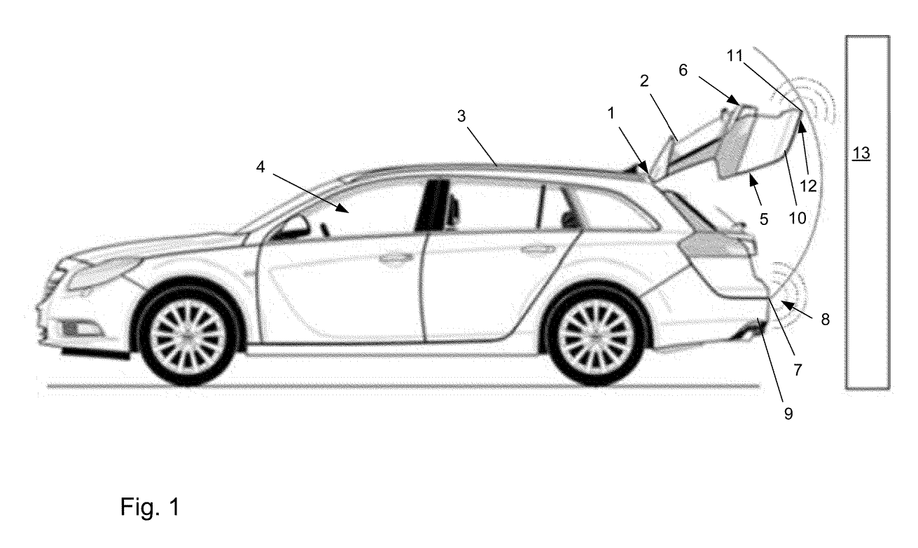

FIG. 2 is a diagrammatic illustration of the motor vehicle with an opened rear flap and with an obstacle on the roof side.

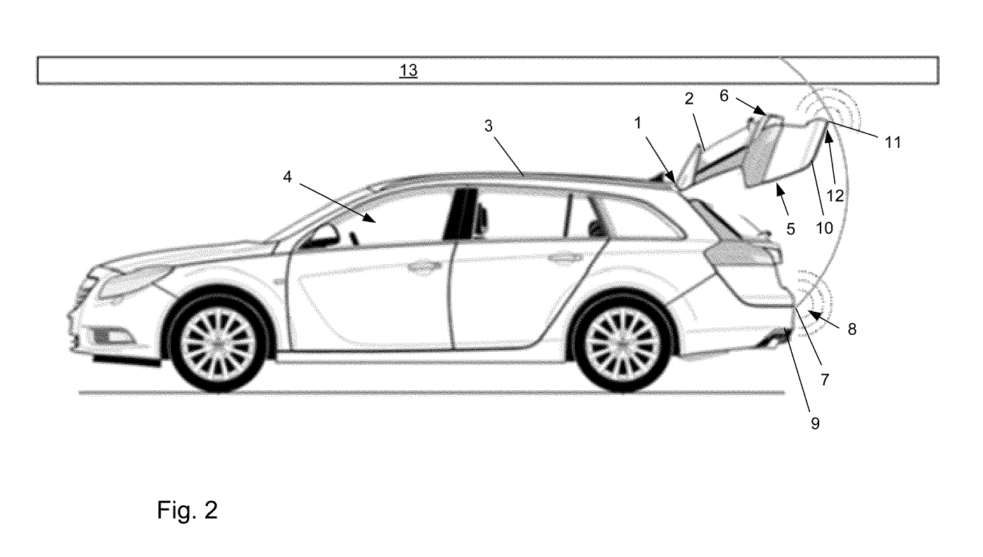

### DETAILED DESCRIPTION

The following detailed description is merely exemplary in nature and is not intended to limit application and uses. Furthermore, there is no intention to be bound by any theory presented in the preceding background or summary or the following detailed description.

The motor vehicle comprises a rear flap 2, pivotable about a horizontal axis 1, which flap is articulated in the region of a vehicle roof 3 and is to be opened and closed automatically. For the respective pivoting, the user presses a push button in the driver's area 4, i.e., in the interior of the motor vehicle, or on an inner side 5 of the rear flap or on an outer side 6 of the rear flap, a so-called rear flap button, or on a remote control, which comprises further switches, in particular for the central locking. The push button is connected via a control apparatus of the motor vehicle with a device which pivots the rear flap 2 and in particular comprises an electric servomotor. Furthermore, a sensor 8, constructed as a parking sensor 7, is connected with the control apparatus, preferably via a conventional vehicle data bus, which sensor is integrated in a rear bumper 9 of the motor vehicle and detects an approach to an obstacle 13 on the rear side. Moreover, in the region of a rear flap edge 10 lying opposite the axis 1 a sensor 12 is installed, embodied as a distance sensor 11 operating in a contactless manner, which registers an approach to the obstacle 13 that is present in the pivoting region of the rear flap 2. As both sensors 8, 12 also perceive obstacles which do not constitute a danger for the rear flap 2, a measurement for a minimum distance is deposited in the control apparatus.

When the user actuates the push button of the remote control, he is possibly situated at a location from which he cannot accurately perceive the conditions in the rear region of the motor vehicle. In order to avoid damage to the rear flap 2 owing to an obstacle on pivoting, the two sensors 8, 12 are interrogated as to the presence of an obstacle 13, which is situated at a distance from the rear of the motor vehicle which is less than the stored minimum distance. If no obstacle is present, the pivoting of the rear flap 2 begins, for example, for opening with the servomotor. On pivoting, at least the distance sensor 11 associated with the rear flap 2 detects the region which the free flap edge 10 sweeps through. If the distance sensor 11 detects an obstacle 13, which is situated at a distance from the free rear flap edge 10, which is less than the stored minimum distance, it stops the pivoting process of the rear flap 2 immediately by a corresponding actuation of the servomotor, in order to avoid damage.

Of course, the sensors 8, 12, a plurality of which can be provided, operate not only on opening the rear flap 2, but also on closing. The mode of operation of the sensors 8, 12 can be cancelled out for example by a special actuation of the push button, in particular by sustained pressing, or on actuation of a special push button, for example on the outer side of the rear flap 2, i.e., the rear flap 2 also pivots when an obstacle is detected at a smaller distance than the minimum distance from the corresponding sensors 8, 12.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A motor vehicle, comprising:
a rear flap that is pivotable about a horizontal axis;
a sensor that is configured to operate a contactless manner and further configured to determine an approach to an obstacle that is present in a pivoting range of the rear flap; and
a device that is configured to interrupt a pivoting of the rear flap when the sensor determines the approach to the obstacle that is present in the pivoting range of the rear flap.

2. The motor vehicle according to claim 1, wherein the sensor is a parking sensor.

3. The motor vehicle according to claim 2, wherein the sensor is integrated in a rear bumper.

4. The motor vehicle according to claim 1, wherein the sensor is a distance sensor installed in the rear flap.

5. The motor vehicle according to claim 4, wherein the sensor is installed in a region of an edge of the rear flap lying opposite the horizontal axis.

6. The motor vehicle according to claim 4, wherein the sensor is a camera coupled with an image processing system.

7. The motor vehicle according to claim 1, wherein the sensor is configured to actuate an optical device for an emission of a signal that is perceptible to a user of the motor vehicle upon on detecting the obstacle.

8. The motor vehicle according to claim 1, wherein the sensor is configured to actuate an acoustic signal device for an emission of a signal that is perceptible to a user of the motor vehicle upon on detecting the obstacle.

9. The motor vehicle according to claim 1, wherein the device comprises a servomotor that is associated with the rear flap and configured to pivot.

10. The motor vehicle according to claim 1, wherein the device is coupled with a push button in a driver area.

11. The motor vehicle according to claim 1, wherein the device is coupled with an inner side of the rear flap.

12. The motor vehicle according to claim 1, wherein the device is coupled with an outer side of the rear flap.

13. The motor vehicle according to claim 1, wherein the device is coupled with a remote control.

14. The motor vehicle according to claim 10, wherein on an actuation of the push button on the outer side of the rear flap the device is configured to pivot the rear flap upon detection of a detected obstacle in the pivoting range.

15. The motor vehicle according to claim 10, wherein for a duration of an actuation of the push button, the device also pivots the rear flap upon detecting a detected obstacle in the pivoting range.

16. The motor vehicle according to claim 1,
wherein a minimum distance is stored in a control apparatus connected with the device and the sensor, and
wherein the device is configured to pivot the rear flap as long as the minimum distance between the obstacle and the sensor is maintained.

17. The motor vehicle according to claim 1, wherein the device cooperates with an electric rear flap lock of a central locking system and prevents an unlocking of the rear flap when falling below a minimum distance between the obstacle and the sensor in a closed position of the rear flap.
